(19) United States
(12) Patent Application Publication
(10) Pub. No.: US 2002/0144935 A1
(43) Pub. Date: Oct. 10, 2002

(54) Wheelbarrow sifter attachment

(76) Inventor: Donna Tims, Alamo, CA (US)

Correspondence Address: Richard W. Goldstein, 2071 Clove Road, Staten Island, NY, 10304, US

(21) Appl. No.: 09/829,276

(22) Filed: Apr. 9, 2001

(51) Int. Cl. B07B 1/00

(52) U.S. Cl. 209/235; 209/352; 209/420; 280/47.31

(57) ABSTRACT

A wheelbarrow sifter attachment including a bin portion coupled with respect to an outer edge of a wheelbarrow. The bin portion has a plurality of drainage slots formed therein.

### BACKGROUND OF THE INVENTION

The present invention relates to a wheelbarrow sifter attachment and more particularly pertains to separating unwanted materials from wanted materials.

The use of material separation tools and devices is known in the prior art. More specifically, material separation tools and devices heretofore devised and utilized for the purpose of sifting materials are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,622,266 to Curtis discloses a sieve adapted to fit the upper rim of a wheelbarrow for use in sifting granular material. U.S. Pat. No. 4,350,584 to Donington discloses a garden sieve capable of being mounted on a wheelbarrow, comprised of a frame and stand assembly. U.S. Pat. No. 4,921,305 to Steer discloses a wheelbarrow.

While these devices fulfill their respective, particular objective and requirements, the aforementioned patents do not describe a wheelbarrow sifter attachment for separating unwanted materials from wanted materials.

In this respect, the wheelbarrow sifter attachment according to the present invention substantially departs from the conventional concepts and designs of the prior art, and in doing so provides an apparatus primarily developed for the purpose of separating unwanted materials from wanted materials.

Therefore, it can be appreciated that there exists a continuing need for a new and improved wheelbarrow sifter attachment which can be used for separating unwanted materials from wanted materials. In this regard, the present invention substantially fulfills this need.

### SUMMARY OF THE INVENTION

In the view of the foregoing disadvantages inherent in the known types of material separation tools and devices now present in the prior art, the present invention provides an improved wheelbarrow sifter attachment. As such, the general purpose of the present invention, which will be described subsequently in greater detail, is to provide a new and improved wheelbarrow sifter attachment which has all the advantages of the prior art and none of the disadvantages.

To attain this, the present invention essentially comprises a bin portion having a generally rectangular configuration. The bin portion is coupled with respect to an outer edge of a wheelbarrow. The bin portion is defined by an open upper end, a closed lower end, a front wall, a back wall, and opposed side walls. The bin portion has a plurality of drainage slots formed within the closed lower end and the back wall thereof. The bin portion has a peripheral flange secured to the open upper end thereof. The peripheral edge includes a rear segment. The rear segment is adapted for pivotally coupling with the outer edge of the wheelbarrow.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved wheelbarrow sifter attachment which has all the advantages of the prior art material separation tools and devices and none of the disadvantages.

It is another object of the present invention to provide a new and improved wheelbarrow sifter attachment which may be easily and efficiently manufactured and marketed.

It is a further object of the present invention to provide a new and improved wheelbarrow sifter attachment which is of durable and reliable construction.

An even further object of the present invention is to provide a new and improved wheelbarrow sifter attachment which is susceptible of a low cost of manufacture with regard to both materials and labor, and which accordingly is then susceptible of low prices of sale to the consuming public, thereby making such a wheelbarrow sifter attachment economically available to the buying public.

Even still another object of the present invention is to provide a new and improved wheelbarrow sifter attachment for separating unwanted materials from wanted materials.

Lastly, it is an object of the present invention to provide a new and improved wheelbarrow sifter attachment including a bin portion coupled with respect to an outer edge of a wheelbarrow. The bin portion has a plurality of drainage slots formed therein.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the wheelbarrow sifter attachment constructed in accordance with the principles of the present invention.

FIG. 2 is a perspective view of the present invention illustrated in use.

The same reference numerals refer to the same parts through the various figures.

### DESCRIPTION OF THE PREFERRED EMBODIMENT

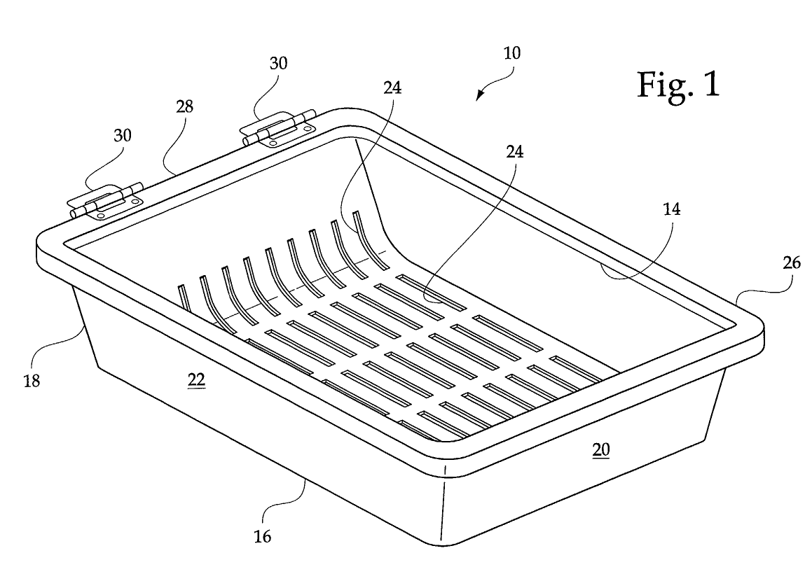

With reference now to the drawings, and in particular, to FIGS. 1 through two thereof, the preferred embodiment of the new and improved wheelbarrow sifter attachment embodying the principles and concepts of the present invention and generally designated by the reference number 10 will be described.

Specifically, it will be noted in the various Figures that the device relates to a wheelbarrow sifter attachment for separating unwanted materials from wanted materials.

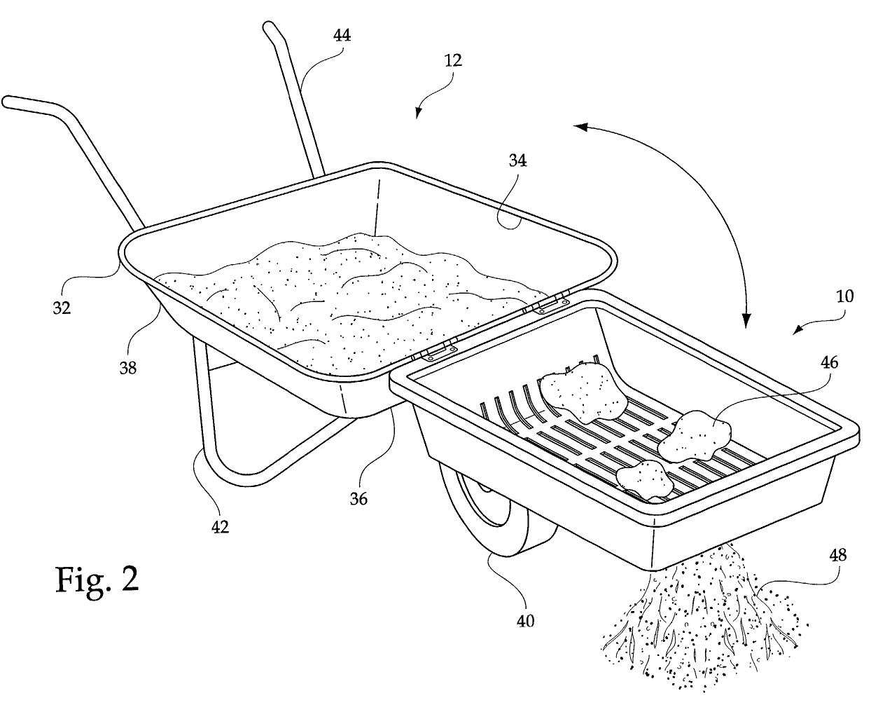

The present invention is essentially comprised of a bin portion 10. Note FIG. 1. The bin portion 10 has a generally rectangular configuration. The bin portion 10 is coupled with respect to an outer edge of a wheelbarrow 12. Note FIG. 2. The bin portion 10 is defined by an open upper end 14, a closed lower end 16, a front wall 18, a back wall 20, and opposed side walls 22. The bin portion 10 has a plurality of drainage slots 24 formed within the closed lower end 16 and the back wall 20 thereof. The bin portion 10 has a peripheral flange 26 secured to the open upper end 14 thereof. The peripheral edge 26 includes a rear segment 28. The rear segment 28 is adapted for pivotally coupling with the outer edge of the wheelbarrow 12. Ideally, the bin portion 10 will be provided with a pair of hinges 30 to facilitate the pivotal coupling to the wheelbarrow 12.

The present invention is designed for use with a wheelbarrow 12. Note FIG. 2. Specifically, the present invention could be made as an after market accessory item for wheelbarrows or incorporated into the design of new wheelbarrows. Typically, the wheelbarrow 12 has a central storage container 32. The central storage container 32 has an open upper end 34, a closed lower end 36, and a peripheral side wall 38 therebetween. The wheelbarrow 12 includes a forward wheel 40 and two support stands 42 secured to the closed lower end 36 of the central storage container 32. The wheelbarrow 12 includes a pair of handles 44 extending rearwardly from the peripheral side wall 38 of the central storage container 32.

Additionally, the bin portion 10 could be provided with suspension means to allow the bin portion 10 to remain in a fixed position relative to the wheelbarrow 12. The suspension means could be support wires that would hang from a ceiling area that could be connected with the bin portion 10 or a support stand that could be positioned below the bin portion 10 to temporarily fix its position with respect to the wheelbarrow 12.

In use, the present invention will allow unwanted materials to be sifted from wanted materials whereupon, the unwanted materials can be dumped from the bin portion 10 into the wheelbarrow 12 for later disposal. The present invention was designed principally for use in horse stalls where manure 46 would be scooped into the bin portion 10 so that the dry shavings 48 could be separated from the manure 46 and remain on the floor for the horses. Once the dry shavings 48 have fallen through the drainage slots 24, the bin portion 10 could be pivoted upwardly until the manure 46 has been emptied into the wheelbarrow 12.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A wheelbarrow sifter attachment for separating unwanted materials from wanted materials comprising, in combination:
a bin portion having a generally rectangular configuration, the bin portion being coupled with respect to an outer edge of a wheelbarrow, the bin portion being defined by an open upper end, a closed lower end, a front wall, a back wall, and opposed side walls, the bin portion having a plurality of drainage slots formed within the closed lower end and the back wall thereof, the bin portion having a peripheral flange secured to the open upper end thereof, the peripheral edge including a rear segment, the rear segment being adapted for pivotally coupling with the outer edge of the wheelbarrow.

2. A wheelbarrow sifter attachment for separating unwanted materials from wanted materials comprising, in combination:
a bin portion being coupled with respect to an outer edge of a wheelbarrow, the bin portion having a plurality of drainage slots formed therein.

3. The wheelbarrow sifter attachment as set forth in claim two wherein the bin portion has a peripheral flange secured to an open upper end thereof, the peripheral edge including a rear segment, the rear segment being adapted for pivotally coupling with the outer edge of the wheelbarrow.

4. A wheelbarrow sifter attachment for separating unwanted materials from wanted materials comprising, in combination:
a wheelbarrow portion having a central storage container, the central storage container having an open upper end, a closed lower end, and a peripheral side wall therebetween, the wheelbarrow portion including a forward wheel and two support stands secured to the closed lower end of the central storage container, the wheelbarrow portion including a pair of handles extending rearwardly from the peripheral side wall of the central storage container; and
a bin portion having a generally rectangular configuration, the bin portion being coupled with respect to an outer edge of a wheelbarrow, the bin portion being defined by an open upper end, a closed lower end, a front wall, a back wall, and opposed side walls, the bin portion having a plurality of drainage slots formed within the closed lower end and the back wall thereof, the bin portion having a peripheral flange secured to the open upper end thereof, the peripheral edge including a rear segment, the rear segment being adapted for pivotally coupling with the outer edge of the wheelbarrow.
